(19) United States
(12) Patent Application Publication
(10) Pub. No.: US 2023/0273356 A1
(43) Pub. Date: Aug. 31, 2023

(54) COMMUNICATION JUDGMENT METHOD, COMMUNICATION JUDGMENT APPARATUS AND COMMUNICATION JUDGMENT PROGRAM

(71) Applicant: NIPPON TELEGRAPH AND TELEPHONE CORPORATION, Tokyo (JP)

(72) Inventors: Hideki TOSHINAGA, Musashino-shi, Tokyo (JP); Kazuto GOTO, Musashino-shi, Tokyo (JP); Hideyuki TSUBOI, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 18/019,221

(22) PCT Filed: Aug. 5, 2020
(86) PCT No.: PCT/JP2020/029955

§ 371 Date: Feb. 1, 2023

(51) Int. Cl. G02B 5/18; H01Q 15/02

(52) U.S. Cl. CPC G02B 5/1876; H01Q 15/02; H01Q 1/526

(57) ABSTRACT

A shielding object identifying unit identifies a partial point cloud representing a shielding object existing in a Fresnel zone on a basis of point cloud data indicating a position of the shielding object in the Fresnel zone between two wireless stations. A criterion decision unit decides an evaluation criterion of propagation loss by the shielding object on a basis of distribution of the partial point cloud. A determination unit makes determination related to communication between the two wireless stations on a basis of the evaluation criterion.

### TECHNICAL FIELD

The present disclosure relates to a communication determination method, a communication determination device, and a communication determination program.

### BACKGROUND ART

A method of using millimeter waves for a communication network infrastructure using IEEE 802.11ay is proposed. On the other hand, in a high frequency band such as a millimeter wave band or a quasi-millimeter wave band, a radio wave has high rectilinearity, and wraparound due to diffraction or the like cannot be expected, so that the effect of a shielding object greatly affects arrival of a radio wave.

Patent Literature 1 discloses a method of calculating a line of sight between two wireless stations. Furthermore, Non Patent Literature 1 discloses a study of technology of utilizing point cloud data for monitoring a communication network infrastructure.

### CITATION LIST

### Patent Literature

Patent Literature 1: JP 2006-352551 A

### Non Patent Literature

Non Patent Literature 1: “Making the real world into a database using 3D point cloud analysis technology”, [online], Nippon Telegraph and Telephone Corporation, [searched on Jul. 21, 2020], Internet <URL:http://www.ntt.co.jp/RD/active/201702/jp/pdf_jpn/02/B-10_j.pdf>

### SUMMARY OF INVENTION

### Technical Problem

Propagation loss by a shielding object varies depending on the type of the shielding object. For example, a shielding object shielding one surface, such as a building outer wall or an external structure, and a shielding object including chinks, such as a plant, may have different propagation loss even if the shielding rates are the same.

In view of the above circumstances, an object of the present invention is to provide a communication determination method, a communication determination device, and a communication determination program capable of making determination related to communication according to the type of a shielding object between two wireless stations.

### Solution to Problem

One aspect of the present invention is a communication determination method including a shielding object identifying step for identifying a partial point cloud representing a shielding object existing in a Fresnel zone on a basis of point cloud data indicating a position of the shielding object in the Fresnel zone between two wireless stations, a criterion decision step for deciding an evaluation criterion of propagation loss by the shielding object on a basis of distribution of the partial point cloud, and a determination step for making determination related to communication between the two wireless stations on a basis of the evaluation criterion.

### Advantageous Effects of Invention

According to the present invention, determination related to communication can be made according to the type of a shielding object between two wireless stations.

### BRIEF DESCRIPTION OF DRAWINGS

FIG. 1 is a schematic block diagram illustrating a software configuration of a station installation support device according to a first embodiment.

FIG. 2 is an explanatory diagram illustrating a Fresnel zone.

FIG. 3 is a diagram illustrating relation between the Fresnel zone and partial zones.

FIG. 4 is a diagram illustrating relation between the partial zones and approximate columnar bodies.

FIG. 5 is a diagram illustrating relation between the approximate columnar bodies and voxel spaces.

FIG. 6 is a diagram illustrating distribution examples of shielding voxels by shielding objects.

FIG. 7 is a flowchart illustrating a station installation support method by the station installation support device according to the first embodiment.

FIG. 8 is a schematic block diagram illustrating a computer configuration according to at least one embodiment.

### DESCRIPTION OF EMBODIMENTS

### First Embodiment

<<Configuration of Station Installation Support Device 100>>

Hereinafter, an embodiment will be described in detail with reference to the drawings.

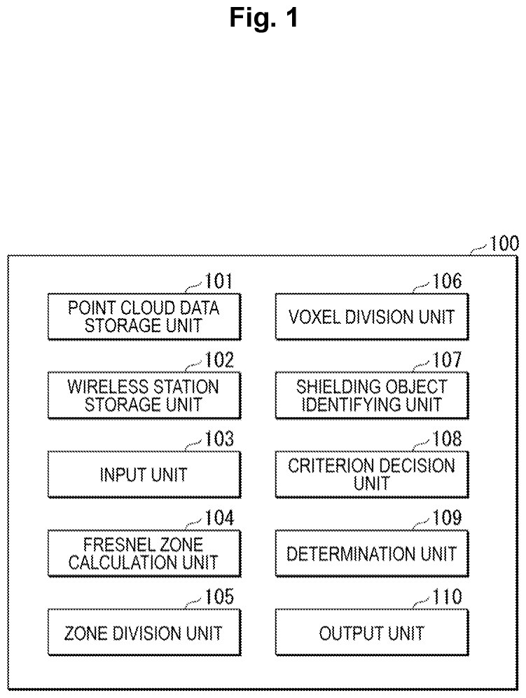

FIG. 1 is a schematic block diagram illustrating a software configuration of a station installation support device 100 according to a first embodiment. The station installation support device 100 supports station installation by a user by determining whether communication between two wireless stations is available on the basis of point cloud data of the environment in which a wireless station is installed.

The station installation support device 100 includes a point cloud data storage unit 101, a wireless station storage unit 102, an input unit 103, a Fresnel zone calculation unit 104, a zone division unit 105, a voxel division unit 106, a shielding object identifying unit 107, a criterion decision unit 108, a determination unit 109, and an output unit 110.

The point cloud data storage unit 101 stores point cloud data of the environment in which a wireless station is installed. For example, the point cloud data storage unit 101 stores point cloud data measured in circular area on which a wireless station related to a communication partner (hereinafter, referred to as a partner wireless station R2) with a newly installed wireless station (hereinafter, referred to as a new wireless station R1) is centered. The partner wireless station R2 may be an existing wireless station or a wireless station to be newly installed. The point cloud data is collected, for example, using a mobile body including a three-dimensional laser scanner. Specifically, while the mobile body is traveling in the vicinity of a wireless station, the three-dimensional laser scanner emits laser light to the surroundings and detects reflected light. The three-dimensional laser scanner identifies a position where the laser light is reflected on the basis of light receiving timing and a light receiving direction of the reflected light. The identified position is a relative position with respect to the three-dimensional laser scanner. The mobile body collects position data by a navigation satellite system (NSS) or the like during traveling. The point cloud data indicating the position of a shielding object in an absolute coordinate system can be obtained by the point cloud data collected by the three-dimensional laser scanner being combined with the position data collected by the mobile body. The density of points included in point cloud data (point cloud density) changes depending on the traveling speed of the mobile body and the distance between a traveling route and a reflection point. Therefore, even in one piece of point cloud data, the point cloud density may be different depending on the spot.

The wireless station storage unit 102 stores three-dimensional position data of the partner wireless station R2. The three-dimensional position data is represented by, for example, latitude, longitude, and height.

The input unit 103 accepts specification of the partner wireless station R2 and input of three-dimensional position data of an installation possibility point of the new wireless station R1 from a user. For example, the input unit 103 causes a map image in which the partner wireless station R2 is centered and an input form of a height to be displayed on the display, and identifies the three-dimensional position data of the installation possibility point on the basis of a point on the map image and the input value of the height.

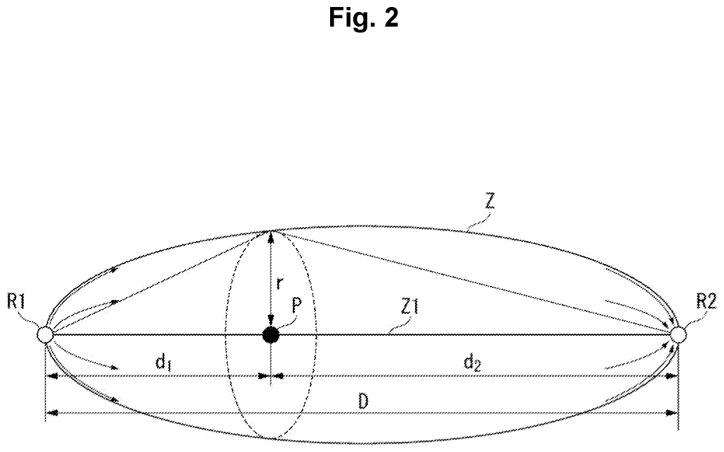

The Fresnel zone calculation unit 104 identifies a spheroid representing a Fresnel zone Z on the basis of the three-dimensional position data of the installation possibility point of the new wireless station R1 and the three-dimensional position data of the partner wireless station R2. FIG. 2 is an explanatory diagram illustrating the Fresnel zone Z. The Fresnel zone Z is a set of propagation paths through which a radio wave radiated from the new wireless station R1 reaches a receiving station 902 in a case where there is no object, between the new wireless station R1 and the partner wireless station R2, shielding the radio wave radiated from the new wireless station R1. As illustrated in FIG. 2, the radio wave is radiated from the new wireless station R1, spreads, and then converges to reach the partner wireless station R2. The Fresnel zone Z is a spheroid having a station connection segment Z1 as the axis. The station connection segment Z1 extends in the line-of-sight direction of the new wireless station R1 and the partner wireless station R2. A radius r of a cross section of the Fresnel zone Z perpendicular to the station connection segment Z1 and positioned at a distance d₁ from the new wireless station R1 and a distance d₂ (=D−d₁) from the partner wireless station R2 is expressed by following Equation (1). Note that D is the length of the station connection segment Z1. In Equation (1), λ represents the wavelength of the radio wave.

$$\begin{matrix}[ Math . 1 ] & \\ r \approx \sqrt{λ \frac{{d}_{1} {d}_{2}}{{d}_{1} + {d}_{2}}} & ( 1 )\end{matrix}$$

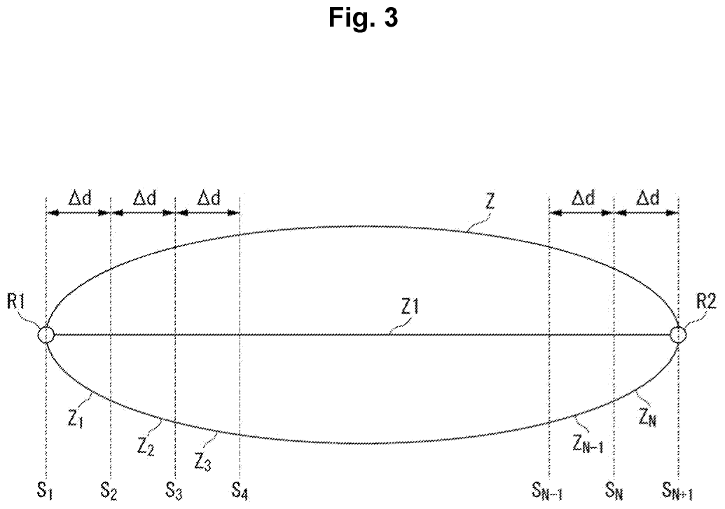

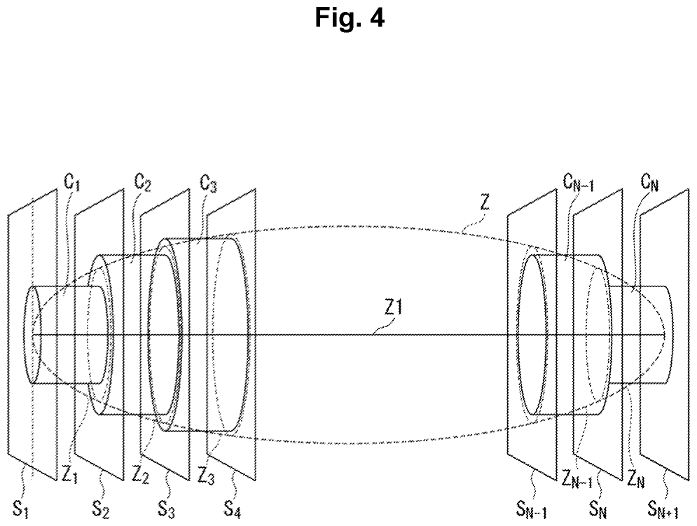

The zone division unit 105 divides the Fresnel zone Z calculated by the Fresnel zone calculation unit 104 into N partial zones z by (N+1) division planes s that divide the station connection segment Z1 into N equal parts. The distances between the division planes s are Δd. FIG. 3 is a diagram illustrating relation between the Fresnel zone Z and the partial zones z. The division planes s are planes orthogonal to the station connection segment Z1. That is, the zone division unit 105 divides the Fresnel zone Z into a plurality of the partial zones z arranged in the line-of-sight direction. Hereinafter, an n-th partial zone among the N partial zones z is referred to as a partial zone zₙ. Furthermore, an n-th one of the (N+1) division planes s is referred to as a division plane sₙ. FIG. 4 is a diagram illustrating relation between the partial zones z and approximate columnar bodies c. In the zone division unit 105, each of the partial zones z is represented by an approximate columnar body c. Hereinafter, an approximate columnar body c representing a partial zone z is referred to as an approximate columnar body cₙ. An approximate columnar body c is columnar body having a bottom surface orthogonal to the station connection segment Z1. An approximate columnar body has a shape approximating a partial zone z. Examples of the shape of an approximate columnar body c include a shape inscribed in a partial zone z, a shape circumscribed on a partial zone z, and a shape inscribed in the central cross section of a partial zone z. The bottom surface of an approximate columnar body c may be circular or polygonal.

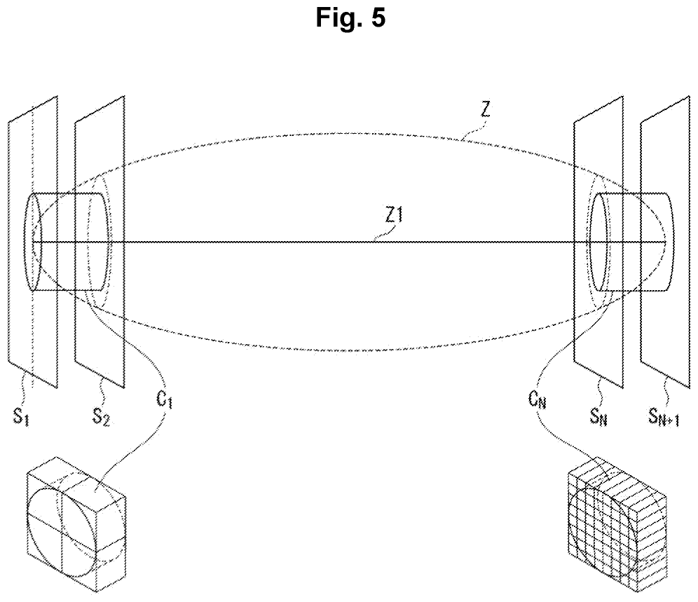

The voxel division unit 106 generates a voxel space v including an approximate columnar body c for each approximate columnar body c. Hereinafter, a voxel space v corresponding to the partial zone zₙ is referred to as a voxel space vₙ. FIG. 5 is a diagram illustrating relation between approximate columnar bodies c and voxel spaces v. A voxel space v is formed by using a plurality of voxels divided in a lattice shape by a plurality of surfaces parallel to the station connection segment Z1. The voxel division unit 106 decides the size of voxels on the basis of the density of points included in an approximate columnar body c (hereinafter, referred to as a partial point cloud) among a plurality of points included in point cloud data. The size of voxels increases or decreases depending on the point cloud density. For example, in an example illustrated in FIG. 5, in a case where the density of the partial point cloud included in an approximate columnar body c₁ is relatively lower than the density of the partial point cloud included in the approximate columnar body c_{N}, the voxel division unit 106 makes the size of the voxels in a voxel space v₁ including the approximate columnar body c₁ larger than the size of the voxels in the voxel space v_{N} including the approximate columnar body c_{N}. The voxel division unit 106 identifies a voxel including at least one point included in the partial point cloud as a shielding voxel among a plurality of the voxels. For example, the voxel division unit 106 gives a “shielding” attribute to a voxel including at least one point included in the partial point cloud.

The shielding object identifying unit 107 extracts a combination of consecutive voxel spaces v each including at least one shielding voxel. For example, in a case where each of the voxel space v₁, a voxel space v₂, a voxel space v₃, a voxel space v₉, a voxel space v₁₂, a voxel space v₁₂, a voxel space v₁₃, and a voxel space v₁₄ includes a shielding voxel, the shielding object identifying unit 107 extracts a combination of the voxel space v₁, the voxel space v₂, and the voxel space v₃, a combination of the voxel space v₉ and the voxel space v₁₂, and a combination of the voxel space v₁₂, the voxel space v₁₃, and the voxel space v₁₄. Since a shielding object is three-dimensional, the shielding object is highly likely to exist across a plurality of partial zones z. Therefore, the shielding object identifying unit 107 identifies a combination of voxel spaces v highly likely to include the same shielding object. Furthermore, the shielding object identifying unit 107 identifies the outer shape of the shielding object in plan view from the line-of-sight direction on the basis of the combination of the voxel spaces v.

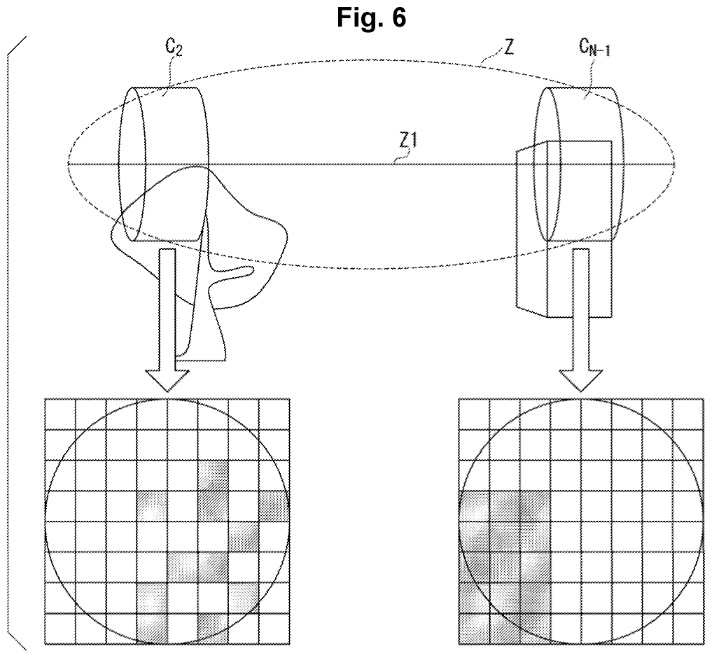

On the basis of the distribution of the shielding voxel in the combination of the voxel spaces v identified by the shielding object identifying unit 107, the criterion decision unit 108 decides a propagation model indicating relation between a shielding rate and propagation loss by the shielding object represented by the combination of the voxel spaces v. In the first embodiment, the propagation model of the shielding object is decided to be either a propagation model of a high-density shielding object or a propagation model of a low-density shielding object. The high-density shielding object is, for example, a shielding object including no chink on the surface such as a building outer wall or an external structure. The low-density shielding object is, for example, a shielding object including many chinks such as a tree. The propagation model of a low-density shielding object is designed such that the value of the propagation loss is smaller than that of the propagation model of a high-density shielding object. FIG. 6 is a diagram illustrating distribution examples of shielding voxels by shielding objects. For example, the criterion decision unit 108 calculates a convex hull of shielding voxels related to a combination of partial zones z, and determines that the shielding object is a high-density shielding object in a case where the shielding voxels are concentrated in the vicinity of the convex hull. On the other hand, in a case where many shielding voxels exist inside the convex hull, the criterion decision unit 108 determines that the shielding object is a low-density shielding object. Specifically, in a case where the average value of the distances between shielding voxels and the convex hull exceeds a predetermined value, the criterion decision unit 108 determines that the shielding object is a low-density shielding object. Point cloud is obtained by measuring light reflected on the surface of a shielding object. Therefore, the point cloud of a high-density shielding object is concentrated on the surface of the shielding object and hardly exists inside. On the other hand, the point cloud of a low-density shielding object may also exist inside the shielding object since light may reach inside the shielding object. Note that, in another embodiment, the criterion decision unit 108 may obtain the surface shape of a shielding object by a method other than a convex hull, and decide the propagation model of the shielding object on the basis of the distances between the shielding voxels and the surface shape.

The determination unit 109 calculates shielding loss in the communication between the new wireless station R1 and the partner wireless station R2 on the basis of a propagation model for each shielding object decided by the criterion decision unit 108 and a shielding rate calculated using the outer shape of each shielding object. The determination unit 109 determines whether the communication between the new wireless station R1 and the partner wireless station R2 is available on the basis of the shielding loss.

The output unit 110 outputs determination result by the determination unit 109.

<<Operation of Station Installation Support Device 100>>

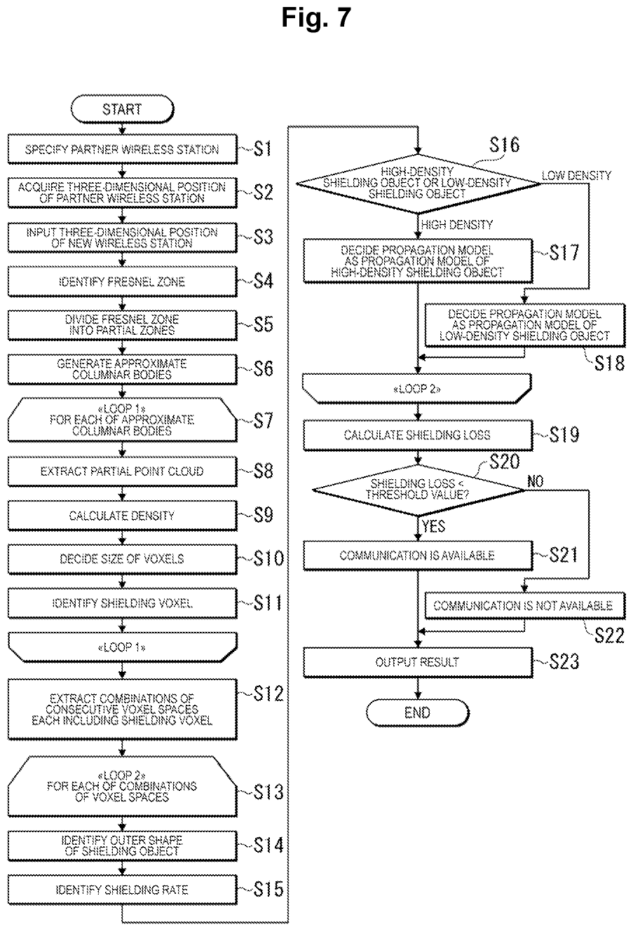

FIG. 7 is a flowchart illustrating a station installation support method by the station installation support device 100 according to the first embodiment. When station installation support processing starts, the input unit 103 of the station installation support device 100 accepts input of specification of a partner wireless station R2 from a user (step S1). For example, the input unit 103 causes a list of wireless stations stored in the wireless station storage unit 102 to be displayed on the display, and accepts a selection of one wireless station included in the list from the user. When the user specifies the partner wireless station R2, the input unit 103 refers to the wireless station storage unit 102 and acquires the three-dimensional position data of the specified partner wireless station R2 (step S2).

The input unit 103 accepts input of the three-dimensional position data of an installation possibility point of a new wireless station R1 (step S3). For example, the input unit 103 causes a map image in which the partner wireless station R2 specified in step S1 is centered and an input form of the height to be displayed on the display, and identifies the three-dimensional position data of the installation possibility point on the basis of the point on the map image and the input value of the height.

The Fresnel zone calculation unit 104 identifies a Fresnel zone Z on the basis of the three-dimensional position data of the partner wireless station R2 identified in step S2 and the three-dimensional position data of the new wireless station R1 input in step S3 (step S4). The zone division unit 105 divides the Fresnel zone Z identified in step S4 at regular intervals Δd along the line-of-sight direction to generate N partial zones z (step S5). The zone division unit 105 generates an approximate columnar body c for each of the partial zones z (step S6).

The station installation support device 100 selects N approximate columnar bodies c generated in step S6 one by one (step S7), and performs the following processing from step S8 to step S11. The voxel division unit 106 reads point cloud data in the vicinity of the partner wireless station R2 specified in step S1 from the point cloud data storage unit 101, and extracts partial point cloud including points existing in a selected approximate columnar body c (step S8). The voxel division unit 106 calculates density of the extracted partial point cloud (step S9). The voxel division unit 106 decides the size of voxels in a voxel space v including the approximate column body c on the basis of the density of the partial point cloud (step S10). The voxel division unit 106 identifies a voxel including at least one point included in the partial point cloud as a shielding voxel among a plurality of the voxels (step S11).

The shielding object identifying unit 107 extracts combinations of consecutive voxel spaces v each including at least one shielding voxel (step S12). The station installation support device 100 selects the combinations of voxel spaces v extracted in step S12 one by one (step S13), and performs the following processing from step S14 to step S18.

The shielding object identifying unit 107 identifies the outer shape of a shielding object by planarly viewing a selected combination of voxel spaces v from the line-of-sight direction (step S14). The shielding object identifying unit 107 identifies a shielding rate of the Fresnel zone Z by the shielding object represented by the selected combination of voxel spaces v on the basis of the outer shape of the shielding object (step S15). The criterion decision unit 108 determines whether the shielding object is a high-density shielding object or a low-density shielding object on the basis of the distribution of shielding voxels related to the selected combination of partial zones z (step S16). For example, the criterion decision unit 108 calculates a convex hull of the shielding voxels, and determines that the shielding object is a high-density shielding object in a case where the standard deviation of the distances between the convex hull and the shielding voxels is equal to or less than a predetermined threshold value. Furthermore, the criterion decision unit 108 determines that the shielding object is a high-density shielding object in a case where the standard deviation of the distances between the convex hull and the shielding voxels is less than the predetermined threshold value.

In a case where the shielding object is determined to be a high-density shielding object (step S16: high density), the criterion decision unit 108 decides a propagation model to be used for evaluating the selected combination of voxel spaces v as the propagation model of a high-density shielding object (step S17). In a case where the shielding object is determined to be a low-density shielding object (step S16: low density), the criterion decision unit 108 decides a propagation model to be used for evaluating the selected combination of voxel spaces v as the propagation model of a low-density shielding object (step S18).

The determination unit 109 calculates shielding loss for each shielding object by substituting shielding rates identified in step S15 for propagation models decided in step S17 or S18 (step S19). The determination unit 109 determines whether the sum of the shielding loss for each shielding object is less than a determination threshold value of communication availability (step S20). In a case where the sum of the shielding loss is less than the determination threshold value (step S20: YES), the determination unit 109 determines that communication with the partner wireless station R2 specified in step S1 is available if the new wireless station R1 is installed at the position input in step S3 (step S21). On the other hand, in a case where the sum of the shielding loss is equal to or larger than the determination threshold value (step S20: NO), the determination unit 109 determines that the communication with the partner wireless station R2 specified in step S1 is not available even if the new wireless station R1 is installed at the position input in step S3 (step S22). The output unit 110 causes determination result of the determination unit 109 to be displayed on the display (step S23).

<<Function and Effect>>

As described above, according to the first embodiment, the station installation support device 100 decides propagation models of shielding objects on the basis of the distribution of a partial point cloud in a Fresnel zone between two wireless stations, and determines whether communication between the two wireless stations is available on the basis of the propagation models. As a result, the station installation support device 100 can make determination related to communication according to the type of shielding objects between two wireless stations.

### Second Embodiment

The station installation support device 100 according to the first embodiment identifies propagation models of shielding objects on the basis of the distribution of a partial point cloud. On the other hand, a station installation support device 100 according to a second embodiment identifies a determination threshold value of communication availability using shielding rates on the basis of the distribution of a partial point cloud.

A criterion decision unit 108 according to the second embodiment identifies the determination threshold value serving as a determination criterion of communication availability on the basis of the distribution of a partial point cloud. The determination threshold value is a threshold value of shielding rates. For example, the criterion decision unit 108 identifies the determination criterion by the following procedure. In the second embodiment, a determination threshold value is determined in advance for each distribution pattern of shielding voxels. The criterion decision unit 108 calculates similarity between distribution patterns associated with respective determination threshold values on the basis of the distribution of a partial point cloud. The criterion decision unit 108 decides a determination criterion associated with a distribution pattern having the highest similarity as a determination criterion to be used for determination.

A determination unit 109 according to the second embodiment compares shielding rates by respective shielding objects identified by a shielding object identifying unit 107 with the determination threshold value, and determines that communication is available in a case where the shielding rates related to all the shielding objects are less than the determination threshold value.

Although one embodiment has been described in detail with reference to the drawings, the specific configuration is not limited to the above configuration, and various design changes and the like can be made. That is, in another embodiment, the order of the above processing may be appropriately changed. Furthermore, some processing may be performed in parallel.

The station installation support device 100 according to the above embodiments may be formed by using a single computer, or the configuration of the station installation support device 100 may be divided into a plurality of computers, and the plurality of computers may cooperate with each other to function as the station installation support device 100.

<Computer Configuration>

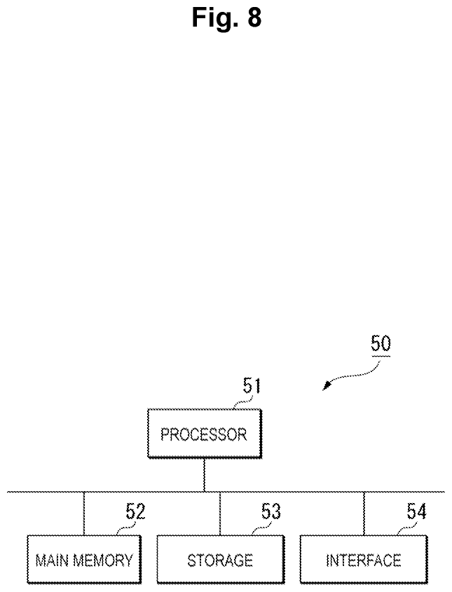

FIG. 8 is a schematic block diagram illustrating a computer configuration according to at least one embodiment.

A computer 50 includes a processor 51, a main memory 52, a storage 53, and an interface 54.

The above station installation support device 100 is implemented by the computer 50. Then, the operation of above each processing unit is stored in the storage 53 in the form of a program. The processor 51 reads the program from the storage 53, deploys the program in the main memory 52, and performs the above processing according to the program. Furthermore, the processor 51 secures a storage area corresponding to above each storage unit in the main memory 52 according to the program. Examples of the processor 51 include a central processing unit (CPU), a graphic processing unit (GPU), a microprocessor, and the like.

The program may be for implementing a part of the functions exerted by the computer 50. For example, the program may cause a function to be exerted in combination with another program already stored in the storage or in combination with another program implemented in another device. Note that, in another embodiment, the computer 50 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions implemented by the processor 51 may be implemented by the integrated circuit. Such an integrated circuit is also included in an example of the processor.

Examples of the storage 53 include a magnetic disk, a magneto-optical disk, an optical disk, a semiconductor memory, and the like. The storage 53 may be an internal medium directly connected to a bus of the computer 50 or an external medium connected to the computer 50 via the interface 54 or a communication line. Furthermore, in a case where this program is distributed to the computer 50 via a communication line, the computer 50 that has received the distribution may deploy the program in the main memory 52 and perform the above processing. In at least one embodiment, the storage 53 is a non-transitory tangible storage medium.

Furthermore, the program may be for implementing a part of the above functions. Furthermore, the program may be a program that implements the above functions in combination with another program already stored in the storage 53, that is, a so-called differential file (differential program).

### REFERENCE SIGNS LIST

100 Station installation support device
101 Point cloud data storage unit
102 Wireless station storage unit
103 Input unit
104 Fresnel zone calculation unit
105 Zone division unit
106 Voxel division unit
107 Shielding object identifying unit
108 Criterion decision unit
109 Determination unit
110 Output unit
50 Computer
51 Processor
52 Main memory
53 Storage
54 Interface
R1 New wireless station
R2 Partner wireless station
Z Fresnel zone
Z1 Station connection segment
c Approximate columnar body
s Division plane
v Voxel space
z Partial Zone

1. A communication determination method comprising:
a shielding object identifying step for identifying a partial point cloud representing a shielding object existing in a Fresnel zone on a basis of point cloud data indicating a position of the shielding object in the Fresnel zone between two wireless stations;
a criterion decision step for deciding an evaluation criterion of propagation loss by the shielding object on a basis of distribution of the partial point cloud; and
a determination step for making determination related to communication between the two wireless stations on a basis of the evaluation criterion.

2. The communication determination method according to claim 1 further comprising
a shielding rate calculating step for calculating a shielding rate of a radio wave in the Fresnel zone by the shielding object on a basis of the partial point cloud,
wherein, in the determination step, determination related to communication between the two wireless stations is made on a basis of the evaluation criterion and the shielding rate.

3. The communication determination method according to claim 2,
wherein, in the criterion decision step, a propagation model indicating relation between a shielding rate and propagation loss by the shielding object is decided on a basis of distribution of the partial point cloud, and
in the determination step, determination related to communication between the two wireless stations is made on a basis of propagation loss obtained from the propagation model and the shielding rate.

4. The communication determination method according to claim 2,
wherein, in the criterion decision step, a threshold value of a shielding rate used for determining communication availability between the two wireless stations is decided on a basis of distribution of the partial point cloud, and
in the determination step, determination of communication availability between the two wireless stations is made by the shielding rate being compared with the threshold value.

5. The communication determination method according to claim 1,
wherein, in the shielding object identifying step,
the point cloud data is divided into a plurality of partial zones arranged in a line-of-sight direction of two wireless stations,
a set of shielding voxels including at least one point included in the point cloud data is identified among a plurality of voxels partitioning each of the partial zones, and
a plurality of consecutive partial zones in which the shielding voxels exist is identified as shielding zones representing a shielding object existing in the Fresnel zone, and
in the criterion decision step, the evaluation criterion is decided on a basis of distribution of the shielding voxels in the shielding zones.

6. A communication determination device comprising:
a processor; and
a storage medium having computer program instructions stored thereon, when executed by the processor, perform to:
identifies a partial point cloud representing a shielding object existing in a Fresnel zone on a basis of point cloud data indicating a position of the shielding object in the Fresnel zone between two wireless stations;
decides an evaluation criterion of propagation loss by the shielding object on a basis of distribution of the partial point cloud; and
makes determination related to communication between the two wireless stations on a basis of the evaluation criterion.

7. A non-transitory computer-readable medium having computer-executable instructions that, upon execution of the instructions by a processor of a computer, cause the computer to perform:
a partial point cloud identifying step for identifying a partial point cloud representing a shielding object existing in a Fresnel zone on a basis of point cloud data indicating a position of the shielding object in the Fresnel zone between two wireless stations;
a criterion decision step for deciding an evaluation criterion of propagation loss by the shielding object on a basis of distribution of the partial point cloud; and
a determination step for making determination related to communication between the two wireless stations on a basis of the evaluation criterion.
